(19) United States
(12) Patent Application Publication
(10) Pub. No.: US 2005/0281907 A1
(43) Pub. Date: Dec. 22, 2005

(54) Plant for producing products assembled of injection-molded plastic components

(76) Inventors: Johan Rinman, Aneby (SE); Robert Axelsson, Granna (SE)

Correspondence Address: WINSTON & STRAWN LLP, 1700 K STREET, N.W., WASHINGTON, DC, 20006, US

(21) Appl. No.: 11/190,283

(22) Filed: Jul. 26, 2005

Related U.S. Application Data
(63) Continuation of application No. PCT/EP04/00617, filed on Jan. 26, 2004.

(30) Foreign Application Priority Data
Jan. 28, 2003 (SE) SE 0300218-5

(51) Int. Cl. B29C 45/27

(52) U.S. Cl. 425/575

(57) ABSTRACT

A plant for producing products assembled of injection-molded plastic components. The plant includes a conveying system with one or more rails for conveying the components through the plant, a longitudinal groove formed in each rail for accommodating at least one suspension part of each of the sprues used for injection-molding the components, and a member for slidably displacing the suspension parts in the longitudinal grooves while the sprues are still connected with their components. The plant has a simple and inexpensive construction while also providing a very high production rate.

### CROSS-REFERENCE TO RELATED APPLICATION

This application is a continuation of International application PCT/EP2004/000617 filed Jan. 26, 2004, the entire content of each of which is expressly incorporated herein by reference thereto.

### BACKGROUND ART

The invention relates to a method for transporting and/or assembling injection molded components, and a plant for producing products assembled of injection-molded plastic components, comprising at least two injection-molding machines and an assembling station for assembling the components.

Very many products are assembled of injection-molded plastic components of different kinds. Each kind of component is injection-molded by means of a special mold mounted in an injection-molding machine. The finished components are normally collected in a casing. The same machine is also often used to injection-mold the other components or some of them. The casings with the components are then transported to a station for separating the components from their sprues and thereafter to an assembling station where the components are manually and/or by means of robots assembled to the finished product. The handling and assembling of the components in this way, however, is very labor-intensive and costly and moreover the production capacity is relatively low.

When a larger capacity is desired, one or more injection-molding machine is used for each component. The production rates of these machines are preferably the same thereby ensuring that the different components can be both separated from their sprues and arrive at an assembling station at the same time. Thereby is it possible to successively assemble the components in the same sequence as they arrive at the assembling station.

The production capacity is, however, limited by the possible production rate at the separation station and assembling station. This production rate is relatively low, since the different components arrive to the stations in an unarranged orientation and therefore first need to be correctly orientated. The separation and assembling of the components is therefore also relatively labor-intensive and costly in this case.

To avoid separation of the components the U.S. Pat. No. 6,360,899 discloses the production of a number of injection-molded components with a common sprue. The components are not separated from the sprue but are sold as one piece. The pieces are separated from the sprue by the end user and used as light holders. The sprue is used as a cord wrap. No assembly of the components is performed and how the sprue is transported is not discussed in this document.

European patent application 1,164,000 describes a method for manufacturing an optical disc. The optical disc described herein comprises two disc halves, which are bonded together to form a single disc at an assembly station. The two halves are provided from separate injection molding units. This is a very specific manufacturing method suited for optical discs and the document is furthermore silent on how and where the disc halves are separated from their sprues.

British patent 701452 discloses a method for injection-molding and assembling parts. In order to avoid variations in tolerances, mating parts in an assembly are produced in the same mold and thereby receive a common sprue. The parts are afterwards one by one stamped out of the sprue in a machine and assembled with its mating part. By producing two different parts in one mold, however, the production of the molds gets expensive and if one of the parts needs to be modified the whole mold needs to be replaced. Likewise if an assembly consists of more than two parts the molds would be very costly to produce since all the parts need be formed in a single mold.

Thus, improvements in these type devices is desired.

### SUMMARY OF THE INVENTION

In one aspect of the invention a method is provided for in an easy and an expedient way transporting and/or assembling inject-molded plastic components by means of the sprue originally connected to the components.

In another aspect according to the invention, a plant is provided of the type mentioned in the opening paragraph, but which is less labor-intensive and costly than known hitherto.

In third aspect according to the invention, a plant is provided of the type mentioned in the opening paragraph, but which has a higher production rate than known hitherto.

In a forth aspect according to the invention, a plant is provided of the type mentioned in the opening paragraph, but which has a simple, cheap and effective conveying system for conveying the components of the products through the plant.

In a fifth aspect according to the invention, a plant is provided of the type mentioned in the opening paragraph, but which automatically orientates the components in the correct way during the production process.

In a sixth aspect according to the invention, a plant is provided of the type mentioned in the opening paragraph, but which has a conveying system that is used in the separating and assembling operations.

In a seventh aspect according to the invention, a method is provided of the type mentioned in the opening paragraph to, in a simple, cheap and effective way, assemble injection-molded plastic components of different kinds into finished products at a higher rate than known hitherto.

The method according to the invention comprises injection molding of the components in such a way, that at least two components have a common sprue for each inject-molding operation and that the sprues are used for transporting and/or assembling the components. The sprues are conventionally disconnected from the components immediately after each injection-molding operation, whereby the components need to be orientated before at least the assembling operation. This orientation process is labor-intensive and costly. This problem, however, is advantageously remedied by according to the invention using the sprues for transporting and assembling the components manually or by means of robots.

The plant according to the invention comprises a conveying system for conveying the sprues, still connected with the components, formed during the injection-molding process, from the injection-molding machines to the assembling station in such a way that the sprues arrive to this station in a predetermined orientated state.

The mold for injection-molding a component is normally equipped with channels for injecting the hot and plasticized plastic into the cavity formed in the mold for molding the component as a cast of the cavity, thereby at the same time also molding the sprues as a cast of the channels. For obtaining a large production rate and an economic production, the mold will normally be designed to mold multiple components simultaneously, whereby these components get a common sprue.

As is clear from the above-mentioned explanation, the sprues are necessary for injection-molding the components. But in a conventional plant they are labor-intensive and costly to handle in the subsequent production where they are normally separated from the components in a production step immediately after the molding operation.

In contrast, the sprues, in the plant according to the invention, are utilized in the production process for carrying the components from the injection-molding machines to the assembling station in a predetermined orientated state, allowing the components to be securely, easily and quickly assembled, resulting in a high production rate with less effort and cost than in conventional processes.

A feeding robot can be placed at each injection-molding machine for catching the sprues, when being ejected from the injection-molding machine, and carrying them at least part of the way to the assembling station. In addition at least one assembling robot can be placed at the assembling station for receiving and assembling the components. The orientation of the components, which arrive at the assembling station, is therefore advantageously predetermined already from the beginning of the process.

The conveying system can, when only a smaller production capacity is required, be arranged in such a way that the assembling station receives the sprues, connected with the components, directly from the feeding robots. The plant according to this embodiment is very simple and cheap.

When a larger production capacity is required, the conveying system can be comprised of at least one conveyer extending between the feeding robots and the, at least one, assembling robot. The feeding robots feed the conveyer during production with sprues, connected with the components, which at the end of the conveyer are handed over to the assembling robot. The conveyer can, in a preferred embodiment, comprise one or more rails, each having a longitudinal groove for accommodating at least one part of each of the sprues. The conveyer can moreover have means in the form of pneumatic cylinders or air jets for slidably displacing the suspension parts in the longitudinal grooves. The part of each of the sprues is in this case formed as a suspension part, which the feeding robots insert in the longitudinal groove, during the production.

For ensuring that the sprues with the components arrive at the assembling station in the desired orientation the suspension parts and the grooves can be formed in such a way that the suspension parts cannot turn or only turn a little in the grooves around an axis extending in the longitudinal direction of the actual rail. The components will therefore always be kept in the same or nearly the same orientated position in planes extending perpendicular to the rails.

In an advantageous embodiment, where the suspension parts are securely guided in this way in the grooves, the cross section of each groove of the rails can have the shape of a cross and the suspension part of the sprues has a corresponding cross shape.

The component will also be kept in the same or nearly the same orientated position in planes extending in the longitudinal direction of the rails when each sprue has more than one suspension part, whereby the sprues are prevented from turning around axes extending perpendicular to the planes. When each sprue is formed with only two suspension parts interconnected with a cross bar it is advantageously obtained that the sprues are allowed to pass curves on the rails without bending the cross bar, which often consists of stiff plastic.

The conveying system can, for obtaining a very large production capacity, have one or more main rails, each of which is connected with one or more branch rails each being fed by a feeding robot with sprues interconnected with components. The main rails are then supplied with the sprues from their associated branch rails, whereby the different components are conveyed to the assembling station by means of each of their main rails in positions orientated in such a way that the components quickly and easily can be assembled to the desired product.

### BRIEF DESCRIPTION OF THE DRAWINGS

The invention will be explained in greater detail below where further advantageous properties and example embodiments are described with reference to the drawings, in which

FIG. 1 is a flow chart for an embodiment of the plant according to the invention for producing products assembled of injection-molded plastic components,

FIG. 2 shows in a larger scale, seen in perspective, a part of the conveying system of the plant with a number of rails,

FIG. 3 shows a section taken along the line III-III in FIG. 2,

FIG. 4 shows a fragment of the same in a longitudinal section, seen from the side,

FIG. 5 shows a section of another embodiment of a rail to the conveying system,

FIG. 6 shows a fragment of the same in a longitudinal section, seen from above,

FIG. 7 shows, seen in perspective, a fragment of the rail shown in FIGS. 3 and 4 formed with an in-feed for the components,

FIG. 8 shows an assembling station for assembling the component to a finished product,

FIG. 9 shows a product produced by means of the plant, and

FIG. 10 is a flow chart for another embodiment of the plant according to the invention for producing products assembled of injection-molded plastic components.

### DETAILED DESCRIPTION OF PREFERRED EMBODIMENTS

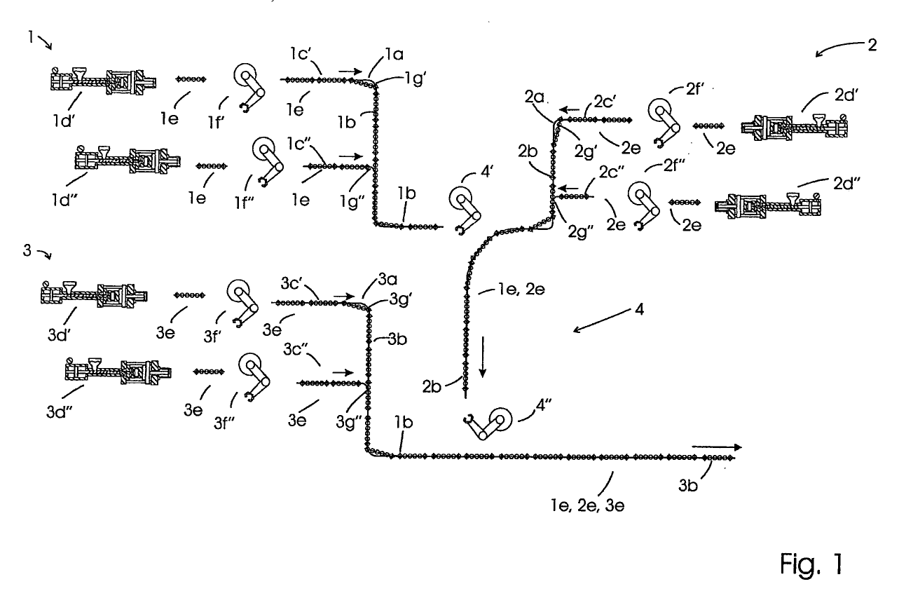

The plant shown in FIG. 1 is in this case used for producing a product assembled of three different injection-molded components. The product and the components are shown here only as signatures.

The plant comprises a first, a second and a third production line 1, 2 and 3, an assembling station 4 and a conveying system 5 consisting of a first conveyer part 1a of the first production line 1, a second conveyer part 2a of the second production line 2, and a third conveyer part 3a of the third production line 3.

The first conveyer part 1a consists, in this case, of a first main rail 1b, which is connected with two first branch rails 1c′ and 1c″, the second conveyer part 2a consists of a second main rail 2b, which is connected with two second branch rails 2c′ and 2c″ and the third conveyer part 3a consists of a third main rail 3b, which is connected with two third branch rails 3c′ and 3c″.

The first production line 1 comprises two first injection-molding machines 1d′ and 1d″ for injection-molding a first kind of injection-molded plastic component 1e, the second production line 2 comprises two second injection-molding machines 2d′ and 2d″ for injection-molding a second kind of injection-molded plastic component 2e, and the third production line 3 comprises two third injection-molding machines 3d′ and 3d″ for injection-molding a third kind of injection-molded plastic component 3c.

The first production line 1 further comprises two first feeding robots 1f′ and f″ for placing the sprues with components 1e injection-molded by the two first injection-molding machines 1d′ and 1d″ on the two first branch rails 1c′ and 1c″, the second production line 2 comprises two second feeding robots 2f′ and 2f″ for placing the sprues with the components 2e injection-molded by the two second injection-molding machines 2d′ and 2d″ on the two second branch rails 2c′ and 2c″, and the third production line 3 comprises two third feeding robots 3f′ and 3f″ for placing the sprues with the components 3e injection-molded by the two third injection-molding machines 3d′ and 3d″ on the two third branch rails 3c′ and 3c″.

Means (not shown in FIG. 1) serve to push the sprues with the components in the direction of the arrows along the branch rails to the main rails and further along them in the direction of the arrows to a separating and assembling station 4.

The assembling station 4 comprises two assembling robots 4′ and 4″ for first assembling the first and second components 1e and 2e on the second main rail 2b and then assembling the already assembled components 1e,2e on the second main rail 2b with the third component 3e on the third main rail 3b to the finished product 1e,2e,3e, which in the direction of the arrow is carried to a packing station and/or a storage (not shown).

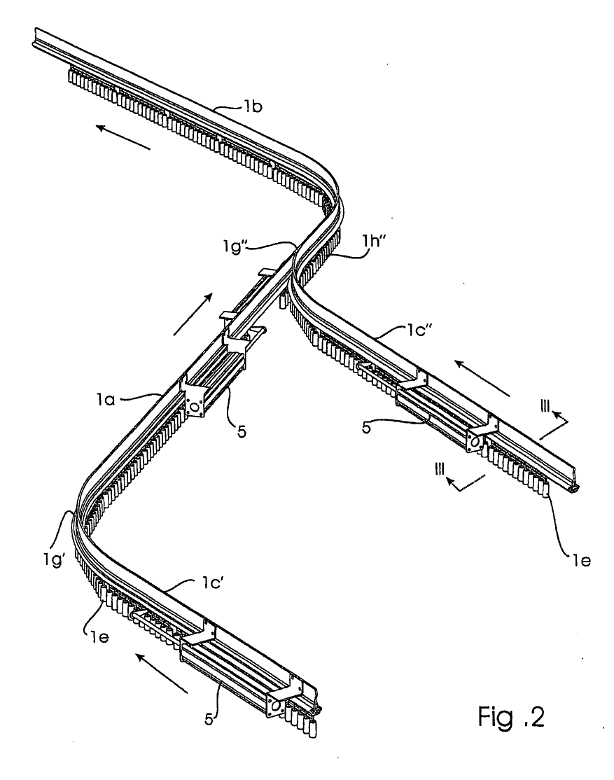

FIG. 2 shows in perspective and in a larger scale the first conveyer part 1a with the first main rail 1b connected with the two branch rails 1c′ and 1c″ by means of connections 1g′ and 1g″ guiding the sprues with the components 1e from the branch rails 1c′ and 1c″ into the main rail 1b along curves 1h′ and 1h″ merging with the main rail 1a.

The sprues with the components 1e are, during the production, pushed in the direction of the arrows along the branch rails 1c′,1c″ to the main rail 1a via the curved connections by means of pneumatic cylinders 5 and along the main rail 1a towards the assembling station.

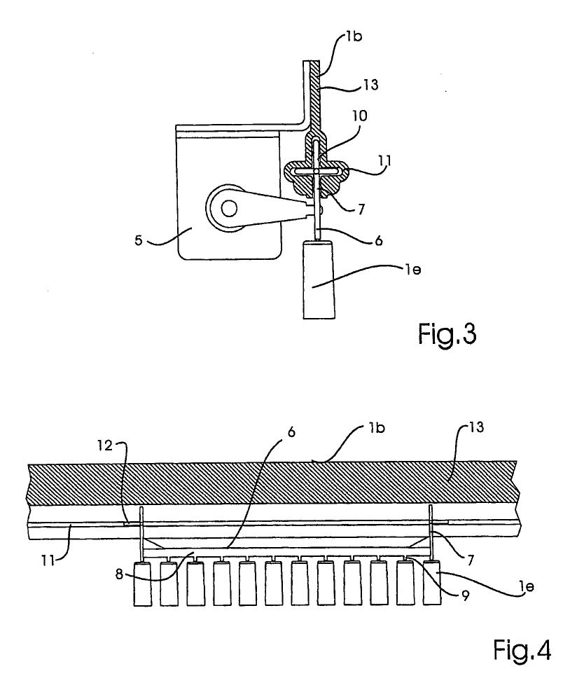

FIGS. 3 and 4 show, in a first embodiment, e.g. the main rail 1b with injection-molded components 1e, which are still connected to the sprue 6, which is injection-molded together with the components.

The sprue has two suspension parts 7 connected with a cross bar 8. Each of the components 1e is connected with the cross bar 8 by means of a tenon 9.

Each suspension part is formed with a cross 10, which is inserted into a correspondingly shaped longitudinal groove 11 in the rail 1b. Each suspension part is furthermore formed with a spacing piece 12 for keeping the sprues with their components at a predetermined mutual distance from each other when being pushed along the rail. A rib 13, which is formed on the rail, serves for hanging up the rail to e.g. the ceiling of the building in which the plant is situated.

Due to the cross shape of the groove and the suspensions parts and also to the fact that the sprue has two suspension parts placed at a mutual distance from each other, the sprue and thereby the components are prevented from tilting in any direction in relation to the rail. The components will therefore advantageously arrive at the assembling station in an already orientated state, whereby it is possible to securely, quickly and easily assemble the components.

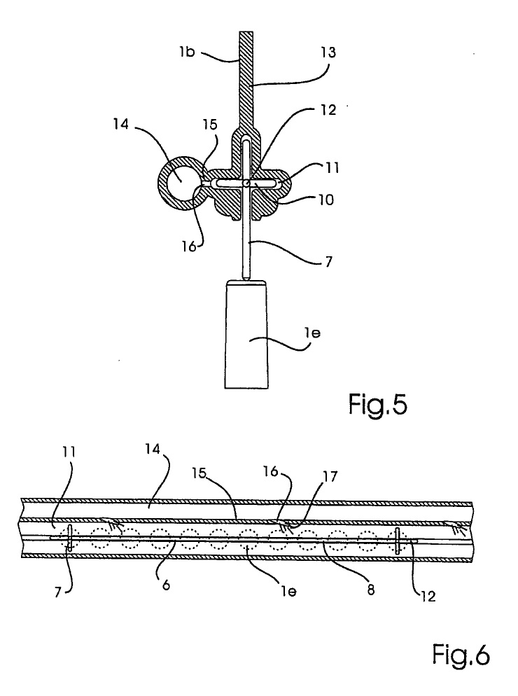

FIGS. 5 and 6 shows e.g. the main rail 1b in a second embodiment. An air tube 14 is formed at the side of the rail. This air tube is connected with a supply of pressurized air (not shown). The suspension parts 7 of the sprue 6 with the components 1e is guided in the longitudinal groove 11 formed in the rail. In the wall 15 between the air tube and the groove a number of air nozzles 16 are formed for, in a direction forming an acute angle with the conveying direction shown by the arrow, sending air jets 17 against the components during operation of the plant, thereby blowing the suspension parts along the rail.

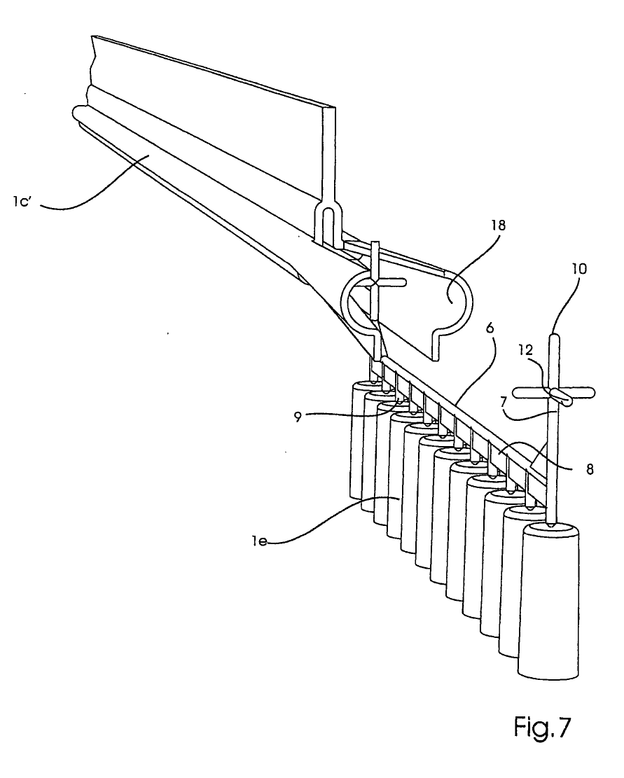

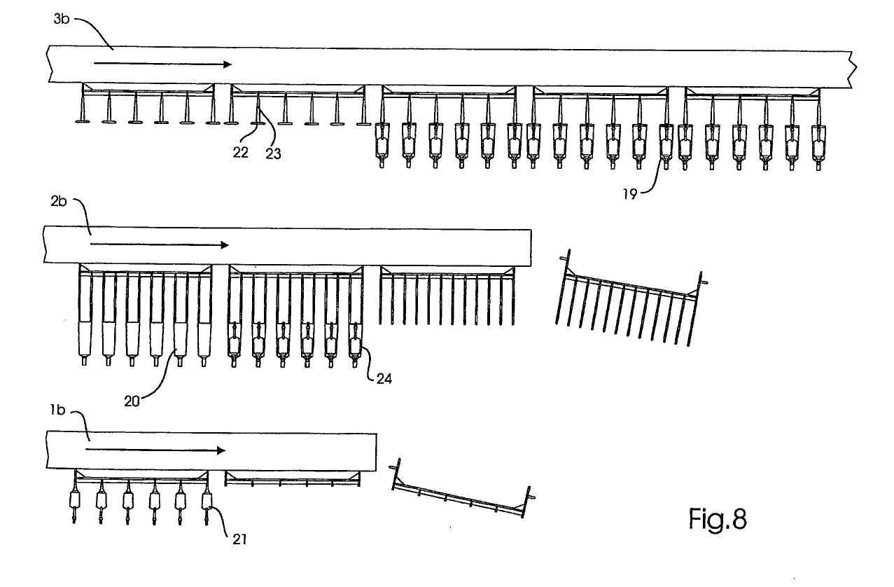

FIG. 7 shows a fragment of e.g. the first branch rail 1c′. The first feeding robot 1f′ seizes, during production, the sprue 6 with the components 1e in synchronization with the production rate of the first injection-molding machine 1d′ and inserts the suspension parts 7 in the longitudinal grove of the rail. This operation is safely and accurately made by means of an in-feed 18 formed like a funnel.

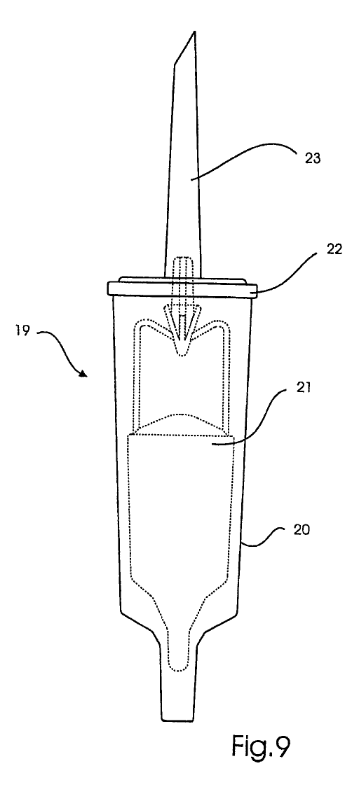

FIG. 8 shows the separation and assembling station 4 for the plant according to the invention. It is, by way of example, assumed that the product produced by means of the plant is a regulator 19 to the infusion set described in Swedish patent application SE 0300137-7. This regulator 19 is shown in FIG. 9 and is assembled of three injection-molded components, namely a housing 20, a floater 21 and a cap 22 with a spike 23. The sprues with these components are pushed forward on the main rails 1b,2b,3b, the floater 21 on the main rail 1b, the housing 20 on the main rail 22 and the cap 23 on the main rail 3b. The rails are in this case placed above each other but could also be placed side by side. The sprues and thereby the components are, as previously mentioned, correctly orientated when arriving at the assembling station thereby allowing the robots 4′ and 4″ to securely, easily and quickly assemble the components. The components are separated from their sprues by means of e.g. shears (not shown).

The assembly operation takes place in the following way. The assembling robot 4′ seizes the floaters 21, which are now separated from their sprues on the first main rail 1b, and places them inside the housings 20, while these are still connected with their sprues on the second main rail 2b. The assembling robot 4″ then seizes the assembly 24 of the housings 20 and the floaters 21, which are now separated from the sprues of the housings on the second main branch 2b, and assembles this assembly 24 with the caps 23 on the third main rail 3b. The assembled regulators 19, which are still connected with the sprues of the caps on the third main rail 3b, are on this main rail then transported to a packing station and/or a storage station (not shown), where the regulators are separated from the sprues and packed into packaging for being supplied to the consumers, e.g. hospitals.

By means of this embodiment of the plant according to the invention a very high output can be obtained. As an example, the output of a plant for producing products composed of 3 parts, having three production lines each fed by 9 injection-molding machines is about 11.000 finished products per hour.

In a variant of the above-described plant there is only one production line, which alternatingly is fed with components from two or more injection-molding machines. The assembling station then is arranged for assembling the components arriving to the assembling station in this way. This plant is suitable for productions where a very high output is not required.

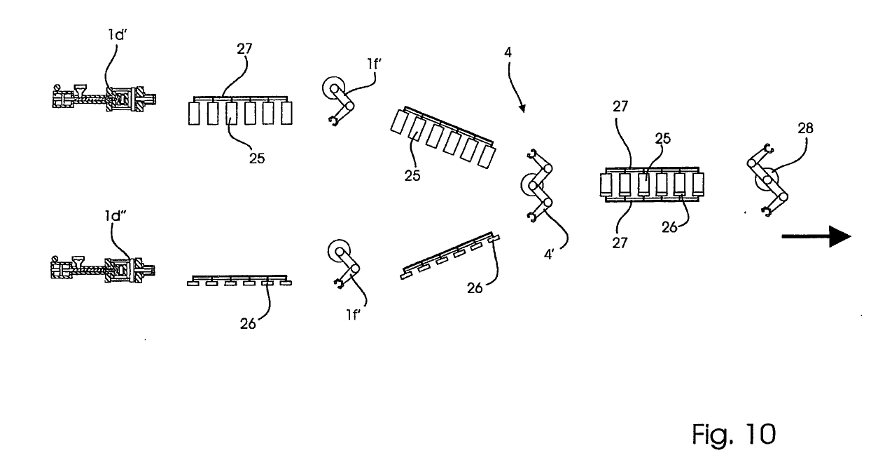

FIG. 10 shows another embodiment for a plant according to the invention for producing a product assembled of two different injection-molded components 25 and 26. Also in this case there is only one production line, which fundamentally corresponds to the production line 1 shown in FIG. 1. The same reference numerals as in FIG. 1-9 are used for the same parts.

The six components 25 and 26, are respectively, during the production, injection-molded by means of the injection-molding machines 1d′ and 1 d″. The components are in FIG. 10 seen immediately after they have been ejected from the machines and are still interconnected with their sprues 27, which in this case are without suspension parts.

The feeding robots 1f′ and 1f″ catch hold of the sprues 27 and hand them over to the assembling robot 4′, which assembles the two parts 25 and 26.

The two sprues 27 are, in this case, formed in such a way that the mutual distance between the six components 25 is the same as the mutual distance between the six components 26. The components 25 and 26 can therefore be assembled while still being interconnected with their sprues 27, thereby improving the speed of the process greatly and even further avoiding the troublesome process of having to orientate and assemble components that have already been separated from their sprues after the injection-molding process.

A further robot 28 catches hold of the assembled components still interconnected with their sprues 27 and brings them to a separation and packing station (not shown).

From the above, it is obvious that keeping the components on the sprue is not only advantageous when using a conveyor system comprising of rails, but also advantageous when the sprues are transported by other means between the different stations, such as an assembly station and a packaging station.

As can be understood, it is essential to keep track of the orientation of the sprue, e.g. by robots or rails, whereby the sprues will be transported and assembled quickly and easily and at a much faster rate than if the components were separated from their sprue immediately after they were ejected from the injection-molding machine.

In the above named description is with reference to the drawing described fully automatically operated embodiments according to the invention using the sprues for transporting and assembling the components.

The sprue can, however, within the scope of the invention also advantageously be used for manually transporting and assembling the components.

1. A method for assembling injection-molded components, which comprises:
injection-molding components in such a way that at least two components possess a common sprue for each injection-molding operation, and
using the sprues for transporting and/or assembling the components.

2. A plant for producing products assembled of injection-molded plastic components, comprising:
at least two injection-molding machines for injection-molding the plastic components,
an assembling station for assembling the components,
a conveying system for conveying the sprues, formed during the injection-molding process, from the injection-molding machines to the assembling station in such a way that the sprues arrive at this station in a predetermined orientation while still connected with the components.

3. The plant of claim 2, further comprising
a feeding robot placed at each injection-molding machines for catching the sprues when ejected from the injection-molding machines, and carrying them at least part of the way to the assembling station, and
at least one assembling robot placed at the assembling station for receiving and assembling the components.

4. The plant of claim 3, wherein the conveying system is arranged in such a way that the assembling robot receives the sprues, interconnected with their components, directly from the feeding robots.

5. The plant of claim 3, wherein the conveying system comprises at least one conveyer extending between the feeding robots and the at least one assembling robot and arranged for being fed with sprues, interconnected with the components, by the feeding robots and for handing them over to the at least one assembling robot.

6. The plant of claim 5, wherein the at least one conveyer comprises at least one rail, which has a longitudinal groove for accommodating at least one suspension part of each of the sprues, and means for slidably displacing the suspension parts in the longitudinal groove.

7. The plant of claim 6, wherein the suspension parts and the grooves are formed in such a way that the suspension parts cannot turn or can only partially turn around an axis extending in the longitudinal direction of the rails.

8. The plant of claim 6, wherein the cross section of each groove of the rails is in the shape of a cross and that the at least one suspension part of the sprues is formed as a cross which fits inside the cross-shaped groove.

9. The plant of claim 5, wherein each sprue is formed with two suspension parts interconnected with a cross bar, and also with a number of tenons which extend from the cross bar and each is connecting a component.

10. The plant of claim 5, wherein the at least one rail is formed with a rib for suspending the rail with the mouth of the groove facing downwards.

11. The plant of claim 5, wherein the at least one rail has an in-feed formed at an end of this for introducing the suspension part of a sprue into the groove of the rail.

12. The plant of claim 5, wherein the conveying system comprises a main rail connected with one or more branch rails, each formed with an in-feed for introducing the suspension part of a sprue into the groove of the respective branch rail.

13. The plant of claim 5, wherein the conveying system comprises two or more main rails each connected with one or more branch rails.

14. The plant of claim 5, wherein the plant comprises an assembling station for assembling components of different kinds supplied to the station by two or more main rails.

15. The plant of claim 5, wherein the means for slidably displacing the suspension parts of the sprues in the longitudinal groove of the rails comprises one or more pneumatic or hydraulic cylinders.

16. The plant of claim 5, wherein the means for slidably displacing the suspension parts of the sprues in the longitudinal groove comprises a number of air nozzles, which are evenly distributed along the groove and each aimed, at least partly, in the displacement direction of the components.
